(19) United States
(12) Patent Application Publication
(10) Pub. No.: US 2008/0054614 A1
(43) Pub. Date: Mar. 6, 2008

(54) Safety Arrangement for the Interior of a Motor Vehicle

(75) Inventors: Michael Drascher, Mühlheim (DE); Holger Langmann, Wiesbaden (DE)

Correspondence Address: INGRASSIA FISHER & LORENZ, P.C., 7150 E. CAMELBACK, STE. 325, SCOTTSDALE, AZ, 85251, US

(73) Assignees: GM GLOBAL TECHNOLOGY OPERATIONS, INC., Detroit, MI (US); JOHNSON CONTROLS INTERIORS GMBH & CO. KG, Grefrath (DE)

(21) Appl. No.: 11/569,787

(22) PCT Filed: May 27, 2005
(86) PCT No.: PCT/EP05/05696

§ 371 Date: Nov. 29, 2006

(30) Foreign Application Priority Data
Jun. 3, 2004 (DE) 10 2004 027 100.3

(51) Int. Cl. B60R 21/045

(52) U.S. Cl. 280/752

(57) ABSTRACT

The invention relates to a safety system for the interior of a motor vehicle. Said safety system comprises a dashboard and a flat damping cushion for absorbing the energy generated during an impact of a passenger's body part. The damping cushion is disposed directly on the surface of the dashboard which faces the interior of the motor vehicle, thus ensuring adequate freedom of movement for the passengers of the vehicle while the space enclosed by the dashboard is not reduced by integrated foam pads. In addition, the inventive system is easy and inexpensive to produce as the damping cushion can be easily mounted on a conventional or slightly modified dashboard.

### CROSS-REFERENCE TO RELATED APPLICATIONS

This application is a U.S. National-Stage entry under 35 U.S.C. § 371 based on International Application No. PCT/EP2005/005696, filed May 27, 2005, which was published under PCT Article 21(2) and which claims priority to German Application No. DE 10 2004 027 100.3, filed Jun. 3, 2004.

### DESCRIPTION

The present invention relates to a safety arrangement for the interior of a motor vehicle with a dashboard and a damping cushion for absorbing the energy generated during an impact of a body part of the occupants. Furthermore, the present invention relates to a damping cushion for use in a safety arrangement of this type.

In the event of accidents with motor vehicles, it frequently occurs that, owing to inertial forces, the vehicle occupants are hurled against components of the vehicle located in the interior thereof, such as, for example the dashboard, and this can lead to serious injuries. In order to minimize this risk of injury, measures are taken, which can substantially be allocated to two complexes. The first complex of measures is directed at largely preventing the vehicle occupants being hurled against the corresponding components in the vehicle interior. This includes, for example, the conventional vehicle belt. The second complex of measures, which also includes the present invention, is directed at keeping the forces, which are generated in the event of an impact of the vehicle occupants on the corresponding component, as low as possible or attenuating them in order to thus reduce the risk of injury.

DE 101 13 508 A1 thus describes an energy-absorbing device, which is arranged in the footwell or knee space of the motor vehicle and is to absorb the energy, which is generated during a vehicle impact, if the person sitting on the vehicle seat is hurled forward. The known safety arrangement comprises a dashboard, on which a device for holding a knee cushion is arranged, the knee cushion facing the knee space. The device for holding the knee cushion is formed from two fastening parts made of sheet metal, which can be stowed in certain regions, so the energy when the knee impacts on the knee cushion can be converted into deformation energy and the impact is damped. The known safety arrangement has various drawbacks, however. The fastening parts carrying the knee cushion thus project a long way into the knee space, so the leg freedom of the vehicle occupants and therefore driving comfort is restricted by the knee cushion. Moreover, the fastening parts carrying the knee cushion are very complex and this makes production thereof laborious and expensive. Furthermore, it is disadvantageous that the knee cushion is not supported in the same manner at all points, as only two fastening parts are provided supporting the sides of the knee cushion. If the vehicle occupants' knees should impact obliquely on the knee cushion, there is the risk of the fastening parts bending away to the side, so the damping effect is largely lost.

A similar safety arrangement is known from DE 39 05 950 C2. This safety arrangement also relates to a knee retaining element. The known knee retaining element extends transversely to the direction of travel through the knee space of the motor vehicle and substantially consists of a hollow profile carrier, which is held laterally on the vehicle's bodywork, and a deformation body arranged thereon, which faces the knees of the vehicle occupants. The deformation body is formed by a thin-walled sheet metal shell and a foam comfort layer arranged thereon, both the sheet metal body and the foam comfort layer extending over the entire width of the knee space. As the known safety arrangement extends over the entire width of the knee space and is fastened, in each case, to the sides of the vehicle bodywork, such as, for example the A-column, it may itself ensure perfect functioning when the vehicle occupants' knee impacts obliquely on the deformation body, as it is not possible for a bending away to occur as in the arrangement known from DE 101 13 508 A1. Nevertheless, this safety arrangement also has the drawbacks that the freedom of movement of the legs of the vehicle occupants are restricted with lasting effect and production is laborious and expensive because of the complexity of the arrangement.

A further safety arrangement is proposed in DE 23 47 908 A1, but the known arrangement is primarily to protect the head and chest region of the vehicle occupants in the event of an impact. Thus, said document discloses a deformer which is arranged even in front of the steering wheel and is arranged via a projecting holder on the steering column or the dashboard. As in the above-mentioned prior art, there are large drawbacks here. The freedom of movement of the vehicle occupants and therefore driving comfort is thus severely restricted by the deformers projecting a long way. Moreover, complicated holders for the deformers are proposed, the complexity of which entails a high manufacturing outlay.

In order to ensure the freedom of movement of the vehicle occupants and therefore to increase driving comfort, it is also known from practice to implement so-called padding measures on the dashboard itself. This means that current dashboards, in which foam pads are integrated, are offered. It is ensured in this manner that no deformation bodies, knee cushions or damping cushions of any type project into the vehicle interior, and this increases the driving comfort. However, this advantage is only achieved with the acceptance of other drawbacks. On the one hand, the production of dashboards with internal foam pads proves to be laborious, so dashboards of this type bring about high production costs. On the other hand, the internal foam pads, which have a thickness of at least 10 mm and are integrated into the dashboards, mean that the space surrounded by the dashboard is reduced, but there is a pressing need this space for further functional components of the motor vehicle, such as, for example, display apparatus.

In order to overcome the above-mentioned drawback, DE 1891785 U1 proposes a frame-like safety pad for the instrument panel of a motor vehicle. To fasten the safety pad to the instrument panel, long hooks, which fit in the lateral air discharge channels close to the windscreen, and screws are provided, by means of which the safety pad is firmly screwed to the instrument panel. The known safety pad has the drawback that it can only be detached with difficulty from the instrument panel if it damaged or is to be replaced by another safety pad in the context of an individual design of the vehicle interior. Thus, DE 1891785 U1 moreover proposes to also provide an adhesive layer on the side of the safety pad facing the instrument panel, so a replacement or change is no longer possible at all.

In contrast, DE 1766400 U1 proposes a protection device for the front seat passenger, which comprises a cushioning layer detachably arranged on the dashboard. In order to ensure the detachability of the cushioning layer, fastening members are provided on the cushioning layer, which can be detachably fastened to corresponding fastening members on the dashboard. Thus, for example, provided on the cushioning layer are clamping pins, which can be inserted into corresponding bores in the dashboard, or fastening loops, which can be suspended on projecting pins, which are provided on the dashboard. Despite the simplified replacabilty of the known cushioning layer, replacing the cushioning layer is still difficult even here; furthermore, secure fastening of the safety pad on the dashboard is not ensured to an adequate extent. Moreover, the risk of injury is increased in the known safety pad.

An object of the invention is therefore to provide a safety arrangement for the interior of a motor vehicle with a dashboard and a damping cushion, the damping cushion of which, on the one hand, can be attached simply and rapidly and can be replaced, and, on the other hand, is securely fastened to the dashboard in a manner ensuring the safety of the vehicle occupants. Furthermore, the invention is based on the object of providing a damping cushion, with which the above-mentioned advantages can be achieved.

### SUMMARY

The safety arrangement according to the invention for the interior of a motor vehicle has a dashboard and a damping cushion. A dashboard can be taken to mean, for example, the complete dashboard, which extends over the entire vehicle width, and also a part of the dashboard, if the complete dashboard is configured in multiple parts. The damping cushion is used for absorbing the energy generated in the event of an impact of a body part of the vehicle occupants. The damping cushion is arranged directly and detachably on the surface of the dashboard, which faces the interior of the motor vehicle. A direct arrangement is in this case taken to mean that no projecting fastening parts, holders or the like are provided, which allow the damping cushion to project into the vehicle interior in a manner which restricts driving comfort. The damping cushion can be displaced from a first position, in which the damping cushion is fastened to the dashboard, into a second position, in which the damping cushion can be removed from the dashboard. This may be achieved, for example, in that a bayonet catch is provided, with it being possible for the damping cushion to be brought into the two positions both by rotation and also by translation. It is obvious that a new damping cushion can be fastened again to the dashboard in the reverse order.

As the damping cushion is arranged directly on the surface of the dashboard, adequate freedom of movement for the vehicle occupants is ensured. Moreover, the space surrounded by the dashboard is not reduced by integrated foam pads. Furthermore, the arrangement according to the invention is simple and economical to produce, as the damping cushion can be easily attached to a conventional or slightly modified dashboard. Thus the damping cushion can also be attached after the dashboard has already been installed in the motor vehicle. Two substantial advantages are connected with the detachable arrangement. On the one hand, a damaged damping cushion can easily be replaced. The damping cushion can also easily be replaced by other damping cushions, which, for example, have another dimensioning, so the arrangement can be adapted to the driver-specific conditions. On the other hand, the vehicle owner can replace standard damping cushions with damping cushions with other patterns or colors in order to design the interior of the motor vehicle individually. The displacability from the first position, in which the damping cushion is fastened to the dashboard, into the second position, in which the damping cushion can be removed from the dashboard, ensures a particular simple and therefore rapid replacement of the damping cushion.

In a particularly preferred embodiment of the safety arrangement according to the invention, the damping cushion is supported in a planar manner on the surface of the dashboard facing the interior of the motor vehicle. In this manner, a largely uniform damping property of the damping cushion is achieved in all directions and in all regions of the damping cushion, as the latter can be supported on the dashboard over the entire side facing the dashboard.

In a further preferred embodiment of the safety arrangement according to the invention, the damping cushion is arranged on the surface of the dashboard facing the knee space of the motor vehicle. This preferred embodiment is to ensure that the knee forces, which (lacuna) owing to the vehicle occupants' knees shooting forward in the event of an accident, are attenuated by the damping cushion and knee injuries are prevented.

According to a further advantageous embodiment of the invention, the damping cushion consists, at least partly, of an elastic material.

As different demands are made of the side facing the dashboard and the side of the damping cushion facing the vehicle interior, namely, on the one hand, good fastening and, on the other hand, gentle interception of the vehicle occupant's body part, the damping cushion has at least two layers of materials with different elasticity in a particularly preferred embodiment of the invention. In this manner, the different sides of the damping cushion are optimally adapted to the respective demands, as becomes clear, in particular in the embodiment described below.

In a particularly preferred embodiment of the safety device according to the invention, the damping cushion has a first layer facing the dashboard and a second layer remote from the dashboard, the first layer being less elastic than the second layer. As the layer of the damping cushion facing the dashboard is less elastic, its object, namely also ensuring a secure fastening to the dashboard, can be better fulfilled. In comparison, the more elastic second layer can absorb the knee forces more gently.

The first layer preferably consists of hard plastics material and the second layer of rubber, in order to achieve the above-mentioned advantages.

In a further preferred embodiment of the safety arrangement according to the invention, fastening means are provided to fasten the damping cushion. The fastening means, on the one hand, comprise a recess and, on the other hand, a projecting lug which can be introduced into the recess in the second position of the damping cushion. The projecting lug has a shoulder, which engages behind the edge of the recess in the first position of the damping cushion. The projecting lug may either be arranged on the damping cushion or on the dashboard, the associated recess then being provided in each case on the opposing part of the arrangement.

In order to ensure a particularly secure engagement of the shoulder behind the edge of the recess, the projecting lug is mushroom-shaped in a preferred embodiment of the invention, the recess having a first section, into which the projecting lug can be introduced, and a narrower second section adjacent thereto. Owing to the mushroom shape, a peripheral shoulder is present, which securely engages behind the edge of the narrower section regardless of the rotational position of the damping cushion in the second position.

In order to ensure a particularly high strength of the projecting lug and therefore secure fastening of the damping cushion to the dashboard, the projecting lug is configured in one piece with the damping cushion or the dashboard. Owing to the one-piece configuration of the projecting lug with the corresponding component of the safety arrangement, a simplified assembly of the arrangement according to the invention is achieved, as additional components can be dispensed with.

As it is possible to completely remove the damping cushion—optionally for aesthetic reasons—the projecting lug is provided, in a further preferred embodiment of the invention, on the damping cushion. It is thus ensured that when the damping cushion is removed, no projecting parts remain on the dashboard which contain a risk of injury. Recesses, on the other hand, are unproblematical and can easily be covered by gluing something over them or otherwise sealed.

The damping cushion according to the invention is used in a safety arrangement according to the invention and has a contact face, which can be placed directly on a surface of a dashboard facing the interior of a motor vehicle. The damping cushion also has fastening means on the cushion side, which can cooperate with fastening means on the dashboard side in such a way that the damping cushion can be displaced from a first position, in which the damping cushion is fastened directly to the surface of the dashboard, into a second position, in which the damping cushion can be removed from the dashboard.

Further embodiments of the damping cushion according to the invention and their advantages emerge from the above description relating to the safety arrangement according to the invention with a damping cushion.

It is obvious that the features mentioned above and still to be described below are not only usable in the respectively disclosed combination, but also in other combinations. The scope of the present invention is only defined by the claims.

### BRIEF DESCRIPTION OF THE DRAWINGS

The present invention will hereinafter be described in conjunction with the following drawing figures, wherein like numerals denote like elements, and

FIG. 1 shows a schematic view of the safety arrangement according to the invention in a side view,

FIG. 2 shows a front view of the safety arrangement according to the invention of FIG. 1,

FIG. 3 shows a side view of the damping cushion fastened to the dashboard, in a sectional view, and

FIG. 4 shows a plan view of the fastening means in the direction of the arrow A of FIG. 3.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

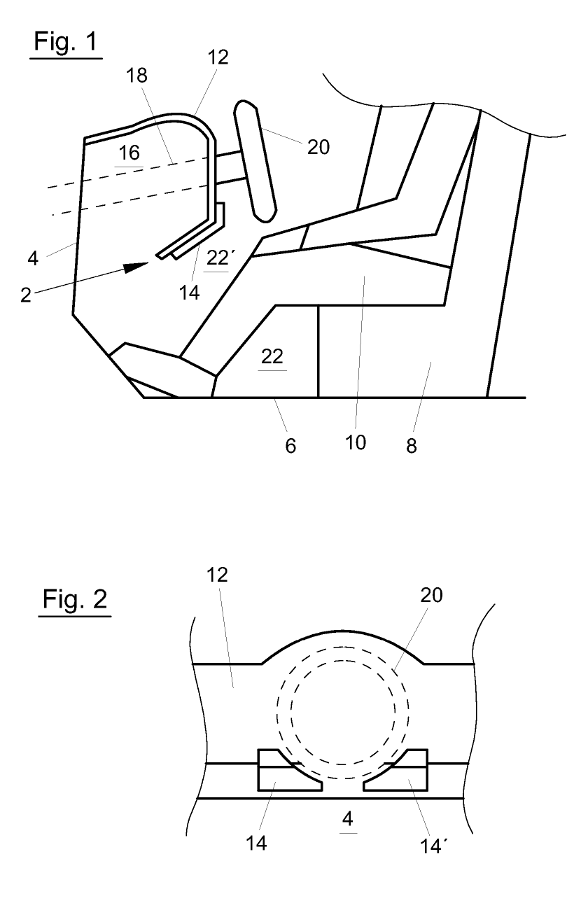

FIG. 1 shows a schematic side view of the driver's area of a motor vehicle with the safety arrangement according to the invention. The engine compartment wall 4, which passes downwardly into the vehicle floor 6, is indicated schematically. A vehicle seat 8, on which a vehicle occupant, in this case the driver 10, is sitting, is provided on the vehicle floor 6. The safety arrangement 2 is arranged between the engine compartment wall 4 and the vehicle seat 8 or driver 10.

The safety arrangement 2 comprises a dashboard 12 and two damping cushions 14, 14′, only the damping cushion 14 being visible in FIG. 1. The dashboard 12 extends, starting from the engine compartment wall 4, in the direction of the vehicle seat 8 and encloses a space 16, in which, for example, parts of the electronics for the displays can be accommodated, but these have not been shown for reasons of clarity. A steering column 18, shown by dashed lines, which exits from the side of the dashboard 12 facing the driver 10, where a steering wheel 20 is arranged to steer the motor vehicle, also extends through the space 16. The footwell 22 is configured between the engine compartment wall 4 and the vehicle seat 8 and between the dashboard 12 and the vehicle floor 6, the footwell being located close to the floor. The knee space 22′ in which the knee of the driver 10 moves is configured above the footwell 22.

As can be seen from FIG. 1, the damping cushions 14, 14′ are arranged directly on the dashboard 12, specifically on the surface facing the interior of the motor vehicle. The damping cushions 14, 14′ are supported, in this case, in a planar manner on the dashboard 12. This includes the fact that the damping cushions 14, 14′ also follow any rounded areas or edges in the dashboard 12, as illustrated in FIG. 1. In the embodiment shown, the knee of the driver 10 is to be protected from injuries, so the damping cushions 14, 14′ are arranged on the surface of the dashboard 12 facing the knee space 22′. As can be seen from FIG. 2, which shows a plan view of the safety arrangement 2 from the point of view of the driver 10, the damping cushion 14 is arranged to the left-hand side of the steering wheel 20 and the damping cushion 14′ to the right-hand side of the steering wheel 20. In this manner, a suitable damping cushion 14, 14′ is provided for each knee of the driver 10, but it is also possible to provide still more damping cushions or even only one large cohesive damping cushion.

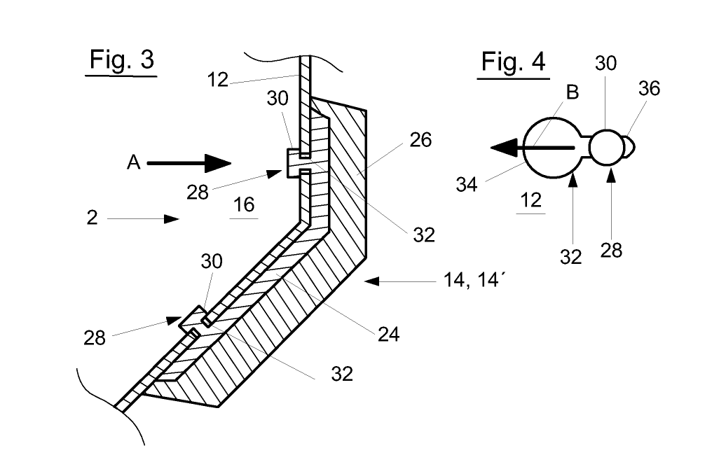

FIG. 3 shows a sectional view of the damping cushion 14, 14′ fastened to the dashboard 12. The damping cushion 14, 14′ is composed of two layers 24 and 26. The first layer 24 faces the dashboard 12, while the second layer 26 arranged on the first layer 24 is remote from the dashboard 12, so the latter faces the knee space 22. The first layer 24, in this case, is less elastic than the second layer 26 in order to ensure a secure and simple fastening of the damping cushion 14, 14′ to the dashboard 12, wherein the fastening will be dealt with later in more detail. In the present example, the first layer 24 is produced from hard plastics material and the second layer 26 from rubber. As can be seen from FIG. 3, the first layer 24 should also advantageously be covered at its edge by the second layer 26, so in the event of a crash, the knee always impacts against the second more elastic layer 26.

In order to fasten the damping cushion 14, 14′ to the dashboard 12, fastening means are provided, which can be divided into fastening means on the damping cushion side and fastening means on the dashboard side. The fastening means on the damping cushion side comprise one or more projecting lugs 28, which are mushroom-shaped. The projecting lugs 28 extend, in this case, from the first layer 24 of the damping cushion 14, 14′ in the direction of the dashboard 12. Owing to the mushroom-shaped configuration of the projecting lug 28, the latter has a peripheral shoulder 30. The fastening means on the dashboard side comprise recesses 32, the recesses 32 being configured in the manner of a keyhole, i.e. they comprise a first section 34 into which the projecting lug 28 can be introduced, and a second section 36. The second section 36 laterally adjoins the first section 34 and is narrower than the first section 34, as can be seen, in particular, in FIG. 4.

In the first position shown of the damping cushion 14, 14′, it is fastened to the dashboard 12; however, it is detachably arranged on the dashboard 12. In the first position, the shoulder 30 of the mushroom-shaped projecting lug 28 engages behind the edge of the elongated section 36 of the recess 32, so the damping cushion 14, 14′ cannot be removed from the dashboard 12. In order to detach the damping cushion 14, 14′ from the dashboard 12, it merely has to be displaced laterally into a second position, so the projecting lug 28 arrives from its position engaging behind the edge of the elongated section 36, into the first section 34 of the recess 32, as is shown with the aid of the arrow B in FIG. 4. The projecting lug 28 can then be guided out through the first section 34 of the recess 32. In this second position, the damping cushion 14, 14′ is thus easy to detach, in that it is removed to the front.

A new damping cushion can then be attached in the reverse order, i.e. the projecting lug 28 is introduced into the first section 34 of the recess 32 in the second position of the damping cushion 14, 14′, in order to then displace the damping cushion 14, 14′ laterally, so the shoulder 30 of the projecting lug 28 engages behind the edge of the elongated second section 36 of the recess 32. The embodiment shown, which has a type of bayonet catch, thus ensures simple and rapid replacement of the damping cushions 14, 14′.

In order to ensure a secure fastening and simple assembly of the safety arrangement, the projecting leg 28 is configured in one piece with the damping cushion 14, 14′, in the present case, in one piece with the first layer 24 of the damping cushion 14, 14′. Although the projecting lug 28 can also be provided on the dashboard 12, while the recess 32 can be configured on the damping cushion, the embodiment shown is, however, more advantageous in as much as after removal of the damping cushions 14, 14′ no projecting lugs, which would mean an increased risk of injury to the vehicle occupants, remain on the dashboard 12.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A safety arrangement for the interior of a motor vehicle comprising:
a dashboard having a surface; and
a damping cushion arranged directly and detachably on the surface of the dashboard and supported in a planar manner on the surface by means of the entire side facing the interior of the motor vehicle, wherein the damping cushion can be displaced from a first position, in which the damping cushion is fastened to the surface, into a second position, in which the damping cushion (14, 14′) can be removed from the surface.

2. The safety arrangement according to claim 1, wherein the damping cushion comprises at least two layers made of materials with different elasticity, the first layer facing the dashboard and also being covered at its edge by the second layer that is remote from the dashboard.

3. The safety arrangement according to claim 1, wherein the damping cushion is arranged on the surface of the dashboard (12) facing a knee space of the motor vehicle in such a way that it follows a rounded area of the dashboard.

4. (canceled)

5. The safety arrangement according to claim 1, wherein the damping cushion is at least partially comprised of an elastic material.

6. The safety arrangement according to claim 2, wherein the first layer is comprised of a hard plastics material and the second layer is comprised of a rubber material.

7. (canceled)

8. The safety arrangement according to claim 1, further comprising a fastener configured for fastening the damping cushion to the surface, the fastener comprising:
a recess;
a projecting lug that can be introduced into recess in the second position of the damping cushion, the projecting lug having a shoulder that engages behind an edge of the recess in the first position.

9. The safety arrangement according to claim 8, wherein the projecting lug is mushroom-shaped and the recess has a first section into which the projecting lug can be introduced, and a narrower second section adjacent thereto.

10. The safety arrangement according to claim 8, wherein the projecting lug is configured in one piece with at least one of the damping cushion and the dashboard.

11. The safety arrangement according to claim 8, wherein the projecting lug is provided on the damping cushion.

12. A damping cushion for use in a safety arrangement of the interior of a motor vehicle that has a dashboard with a surface, comprising:
a contact face that can be placed directly on the surface of the dashboard facing the interior of the motor vehicle in such a way that the entire side facing the dashboard is supported in a planar manner on the surface of the dashboard;
a fastener on the contact face that can cooperate with a second fastener on the dashboard in such a way that the damping cushion can be displaced from a first position, in which the damping cushion is fastened directly to the surface of the dashboard, into a second position, in which the damping cushion can be removed from the dashboard.

13. The safety arrangement according to claim 1, wherein the damping cushion is arranged on the surface of the dashboard facing a knee space of the motor vehicle in such a way that it follows an edge of the dashboard.

14. The safety arrangement according to claim 2, wherein the first layer is less elastic than the second layer.
